(19) United States
(12) Patent Application Publication
(10) Pub. No.: US 2026/0172654 A1
(43) Pub. Date: Jun. 18, 2026

(54) IMAGING MODULE WITH COLOR WHEEL

(71) Applicant: GUANGZHOU LUXVISIONS INNOVATION TECHNOLOGY LIMITED, Guangzhou City (CN)

(72) Inventors: Shih-Chieh Yen, Guangzhou City (CN); Sheng-Chieh Yang, Guangzhou City (CN)

(73) Assignee: GUANGZHOU LUXVISIONS INNOVATION TECHNOLOGY LIMITED, Guangzhou City (CN)

(21) Appl. No.: 19/060,757

(22) Filed: Feb. 23, 2025

Related U.S. Application Data
(60) Provisional application No. 63/687,783, filed on Aug. 28, 2024.

(30) Foreign Application Priority Data
Dec. 16, 2024 (CN) 202411852107.9

(51) Int. Cl. H04N 23/10; G02B 26/00; H04N 23/55

(52) U.S. Cl. CPC H04N 23/125; G02B 26/008; H04N 23/55

(57) ABSTRACT

Provided is an imaging module with a color wheel, which includes an image sensor, a lens set, a color wheel, a light-shielding sheet, and a driving assembly. The lens set is disposed above the image sensor. The color wheel is disposed above the lens set and includes multiple filters with different filter wavelength bands. The light shield sheet is disposed above the color wheel and has a notch. The notch exposes a part of the filters. The driving assembly is configured to drive at least one of the color wheel and the light-shielding sheet to rotate.

### CROSS-REFERENCE TO RELATED APPLICATION

This application claims the priority benefit of U.S. provisional application Ser. No. 63/687,783, filed on Aug. 28, 2024 and China application serial no. 202411852107.9, filed on Dec. 16, 2024. The entirety of each of the above-mentioned patent applications is hereby incorporated by reference herein and made a part of this specification.

### BACKGROUND

### Technical Field

The disclosure relates to an imaging module, and in particular to an imaging module with a color wheel.

### Description of Related Art

The color wheel was originally a key component in digital light processing (DLP) technology, responsible for decomposing the white light of the light source into basic colors such as red, green, and blue to generate color images. The technology is widely applied in commercial, educational and home theater projectors because excellent color reproduction and brightness may be provided.

The color wheel consists of a transparent disk divided into multiple sector regions, each covered with a filter of a different color. Common configurations include red, green, and blue. When the projector is running, the color wheel rotates at a high speed, allowing white light to pass through the filters in proper order, decomposing the light into monochromatic light.

The monochromatic lights are illuminated onto the chip of a digital micro-mirror device (DMD) in proper order. There are millions of tiny mirrors on the DMD chip, each of which corresponds to a pixel in the image. When the light passes through the color wheel, the DMD chip adjusts the tilt angle of the micromirror based on the color of the light to determine whether the light is reflected into the projection lens. The DMD chip may accurately control the brightness and the color of each pixel, ultimately synthesizing a complete color image.

The main advantage of the color wheel is the cost-effectiveness and high efficiency in color projection. Compared with multi-chip DLP projectors, single-chip DLP projectors only need one DMD chip and the color wheel to generate color images, significantly reducing production costs. At the same time, the design optimization of the color wheel can improve color precision and saturation, providing a better viewing experience.

However, there is currently no technology for applying the color wheel to a camera module, so that the color saturation that may be achieved by the current camera module needs to be improved, and the cost of the current camera module is also difficult to be further reduced.

### SUMMARY

The disclosure relates to an imaging module with a color wheel, which can achieve a higher color saturation or have a lower cost.

An embodiment of the disclosure provides an imaging module with a color wheel, including an image sensor, a lens set, a color wheel, a light-shielding sheet, and a driving assembly. The lens set is disposed above the image sensor. The color wheel is disposed above the lens set, and includes multiple filters with different filter wavelength bands. The light-shielding sheet is disposed above the color wheel and has a notch. The notch exposes a part of the filters. The driving assembly is configured to drive at least one of the color wheel and the light-shielding sheet to rotate.

In the imaging module with the color wheel according to the embodiment of the disclosure, the color wheel disposed above the lens set is used, which includes the multiple filters with different filter wavelength bands, and the light-shielding sheet disposed above the color wheel is used, which has the notch to expose a part of the filters. By driving at least one of the color wheel and the light-shielding sheet to rotate, the image sensor may sense images of lights of different wavelength bands in sequence. The images of lights of different wavelength bands may be synthesized into a color image, so that the image sensor may further sense a color image with a higher color saturation. In addition, in the imaging module with the color wheel according to the embodiment of the disclosure, since the color wheel is used to filter out lights of different wavelength bands in sequence, an image sensor with a relatively simple structure may be used, so that the cost of the imaging module can be effectively reduced.

### BRIEF DESCRIPTION OF THE DRAWINGS

FIG. 1A is a perspective schematic view of an imaging module with a color wheel according to an embodiment of the disclosure.

FIG. 1B is a perspective schematic view of the imaging module with the color wheel in FIG. 1A after being cut along an optical axis.

FIG. 2A is a schematic top view of the light-shielding sheet and the color wheel in FIG. 1A.

FIG. 2B is a schematic top view of the light-shielding sheet and the color wheel in FIG. 1A where the light-shielding sheet is presented in a transparent manner.

FIG. 3 is a schematic top view of the color wheel in FIG. 1A.

FIG. 4A is a schematic bottom view of a first magnet, a first coil, an annular circuit board and the color wheel in the imaging module with the color wheel in FIG. 1A.

FIG. 4B is a perspective schematic view of the first coil, the annular circuit board, a second magnet, a second coil, the light-shielding sheet and the color wheel in the imaging module with the color wheel in FIG. 1A.

### DETAILED DESCRIPTION OF DISCLOSED EMBODIMENTS

Reference will now be made in detail to exemplary embodiments of the disclosure, examples of which are illustrated in the accompanying drawings. Whenever possible, the same reference numerals are used in the drawings and the description to refer to the same or like parts.

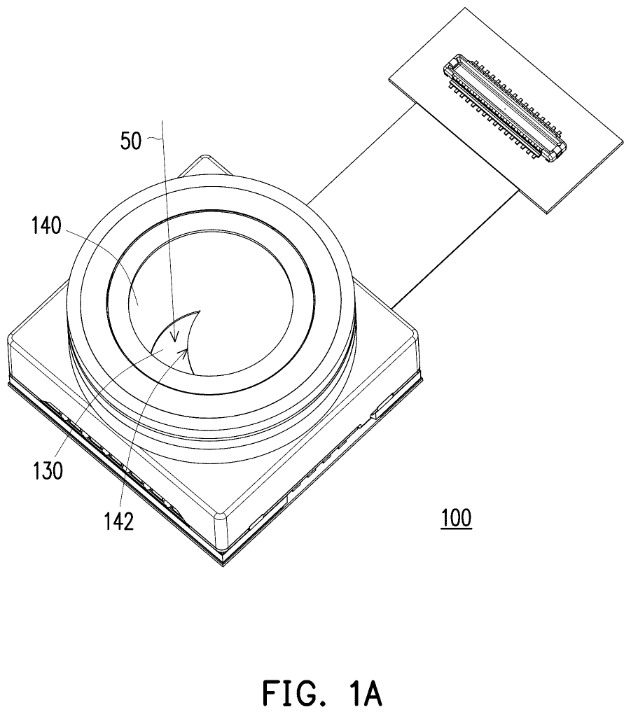

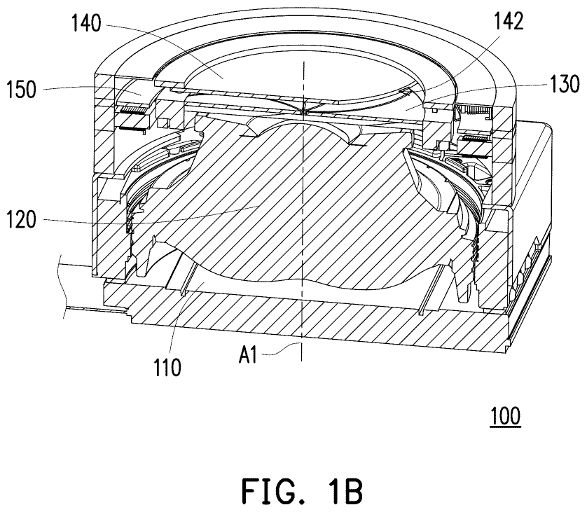

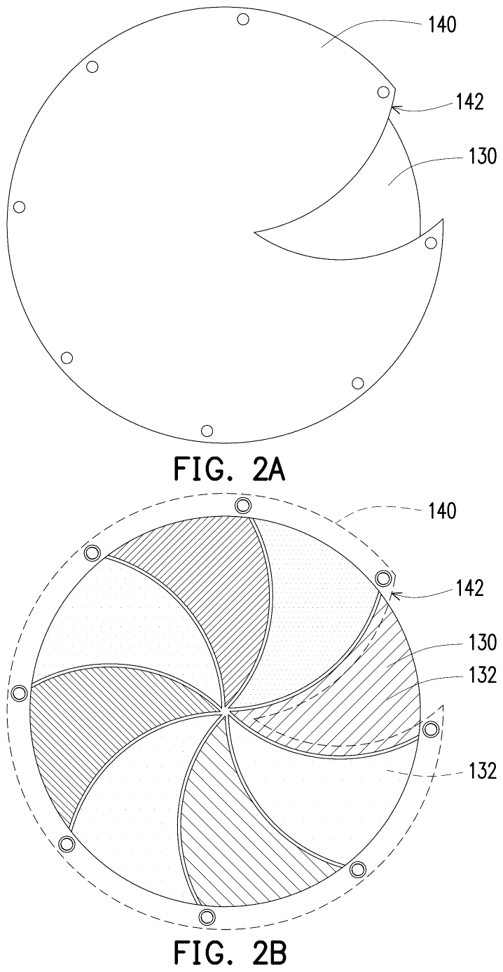

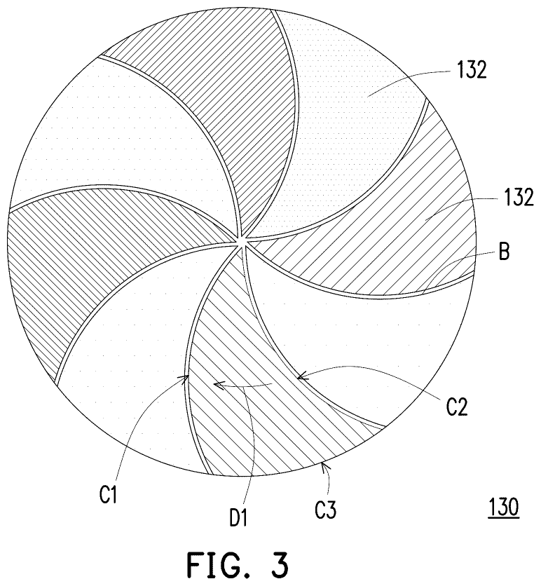

FIG. 1A is a perspective schematic view of an imaging module with a color wheel according to an embodiment of the disclosure. FIG. 1B is a perspective schematic view of the imaging module with the color wheel in FIG. 1A after being cut along an optical axis. FIG. 2A is a schematic top view of the light-shielding sheet and the color wheel in FIG. 1A. FIG. 2B is a schematic top view of the light-shielding sheet and the color wheel in FIG. 1A where the light-shielding sheet is presented in a transparent manner. In FIG. 2B, the transparent drawing of the light-shielding sheet does not mean that the light-shielding sheet may transmit light. Rather, such drawing is to more clearly present the relationship between the notch of the light-shielding sheet and the filters of the color wheel. In addition, FIG. 3 is a schematic top view of the color wheel in FIG. 1A. Please refer to FIG. 1A, FIG. 1B, FIG. 2A, FIG. 2B and FIG. 3. An imaging module 100 with a color wheel according to the embodiment includes an image sensor 110, a lens set 120, a color wheel 130, a light-shielding sheet 140 and a driving assembly 150. The lens set 120 is disposed above the image sensor 110. The lens set 120 may include at least one lens for imaging external objects on the image sensor 110. The color wheel 130 is disposed above the lens set 120 and includes multiple filters 132 with different filter wavelength bands (as shown in FIG. 3). The light-shielding sheet 140 is disposed above the color wheel 130 and has a notch 142. The notch 142 exposes a part of the filters 132.

The driving assembly 150 is configured to drive at least one of the color wheel 130 and the light-shielding sheet 140 to rotate. In the embodiment, the shape of the notch 142 corresponds to the shape of the filters 132. When the driving assembly 150 drives at least one of the color wheel 130 and the light-shielding sheet 140 to rotate, the notch 142 exposes the filters 132 in sequence. In the embodiment, the filters 132 with different filter wavelength bands include a red filter, a green filter, and a blue filter. In an embodiment, the filters 132 with different filter wavelength bands may include at least one of an infrared-transmitting filter and an ultraviolet-transmitting filter. Alternatively, in an embodiment, the filters 132 with different filter wavelength bands may include at least one of a purple filter, a yellow filter, and an orange filter. In FIG. 3, the filters 132 of the color wheel 130 are eight filters, namely, a red filter, a green filter, a blue filter, a purple filter, a yellow filter, an orange filter, an infrared-transmitting filter, and an ultraviolet-transmitting filter. Furthermore, in the embodiment, the filters 132 are in an annular arrangement around an optical axis A1 of the lens set 120. In addition, in the embodiment, the filters 132 may be attached to a substrate, and the substrate may be, for example, a white glass plate, and may be, for example, a circular plate.

A light 50 from an external object may pass through the notch 142 of the filters 140 and is then filtered into a light of a specific wavelength band by the filters 132 of the color wheel 130. Then, the light that has been filtered into the specific wavelength band may be focused to the image sensor 110 by the lens set 120 and imaged on the image sensor 110. When the driving assembly 150 drives at least one of the color wheel 130 and the light-shielding sheet 140 to rotate, the notch 142 of the light-shielding sheet 140 may expose the filters 132 with different filter wavelength bands in sequence to allow lights of different wavelength bands to be imaged on the image sensor 110 in sequence. By recording the timing of the color wheel 130, a controller that is electrically connected to the image sensor 110 and configured to process signals of the image sensor 110 may analyze which wavelength band the image sensed by the image sensor 110 at which time is, and further obtain information of a color image synthesized by images of different wavelength bands.

In an embodiment, the driving assembly 150 is configured to drive the color wheel 130 to rotate when the light-shielding sheet 140 is in a static state, or is configured to drive the light-shielding sheet 140 to rotate when the color wheel 130 is in a static state. In this way, the notch 142 of the light-shielding sheet 140 may expose the filters 132 with different filter wavelength bands in sequence. In the embodiment, the driving assembly 150 may be configured to drive the color wheel 130 to rotate when the light-shielding sheet 140 is in a static state, and drive the light-shielding sheet 140 to rotate when the color wheel 130 is in a static state to allow images of the different wavelength bands to be generated when the notch 142 rotates to different angles relative to the lens set 120, so that the imaging module 100 with the color wheel may obtain complete color image information. That is to say, when the rotation of the color wheel 130 completes one cycle, and the rotation of the light-shielding sheet 140 completes one cycle, the image sensor 110 may obtain complete color image information.

In the embodiment, a rotation of the color wheel 130 is a rotation where the optical axis A1 of the lens set 120 is a rotating axis, and a rotation of the light-shielding sheet 140 is a rotation where the optical axis A1 of the lens set 120 is a rotating axis.

In the imaging module 100 with the color wheel according to the embodiment, the color wheel 130 disposed above the lens set 120 is used. The color wheel 130 includes the multiple filters 132 with different filter wavelength bands. In addition, the light-shielding sheet 140 disposed above the color wheel 130 is used, which has the notch 142 to expose a part of the filters 132. By driving at least one of the color wheel 130 and the light-shielding sheet 140 to rotate, the image sensor 110 may sense images of lights of different wavelength bands in sequence. The images of lights of different wavelength bands may be synthesized into a color image, so that the image sensor 110 may further sense a color image with a higher color saturation. In addition, in the imaging module 100 with the color wheel according to the embodiment, since the color wheel 130 is used to filter out lights of different wavelength bands in sequence, the image sensor 110 with a relatively simple structure may be used, so that the cost of the imaging module can be effectively reduced. The pixels of the image sensor 110 do not need to be divided into sub-pixels of different colors, and the colors of the image sensed by the image sensor 110 may be determined by the filters 132 of the color wheel 130 with a lower cost, so that the cost can be effectively reduced. On the other hand, since the pixels of the image sensor 110 do not need to be divided into sub-pixels of different colors, the pixels of the image sensor 110 may be made smaller, or the resolution of the image sensor 110 may be made higher.

In addition, using the filters 132 with different wavelength bands may not only improve the color accuracy of the image, but also effectively reduce the problem of color deviation. By accurately controlling the spectral characteristics of the filters 132, the technology of the color wheel 130 may implement more realistic color reproduction. In addition, with the continuous advancement of technology, the structure of the color wheel 130 is also continuously optimized, which may provide a wider color gamut and higher brightness.

In the embodiment, a boundary B between two adjacent filters in the filters 132 is arc-shaped. In addition, in the embodiment, each filter 132 of the filters 132 has an arc-shaped convex side C1, an arc-shaped concave side C2, and an arc side C3 connecting the arc-shaped convex side C1 and the arc-shaped concave side C2. A rotation direction D1 of the color wheel 130 is from the arc-shaped concave side C2 to the arc-shaped convex side C1, so that the color wheel 130 may more effectively guide the airflow when rotating rapidly, decrease airflow separation and vortex generation, and thus reduce wind resistance. This design allows the filters 132 to cut the air more smoothly when rotating and decrease energy loss.

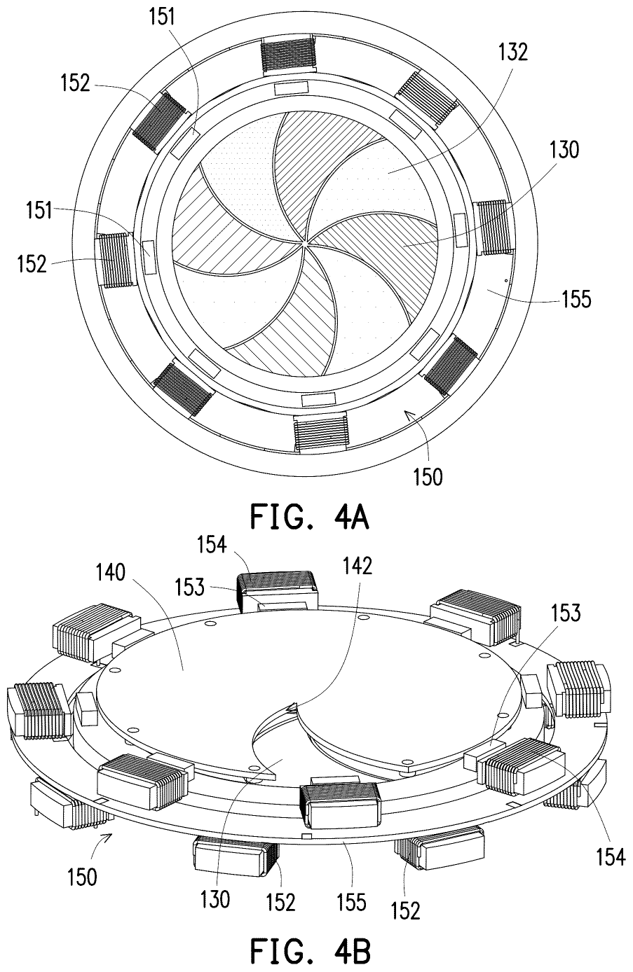

FIG. 4A is a schematic bottom view of a first magnet, a first coil, an annular circuit board and the color wheel in the imaging module with the color wheel in FIG. 1A. FIG. 4B is a perspective schematic view of the first coil, the annular circuit board, a second magnet, a second coil, the light-shielding sheet and the color wheel in the imaging module with the color wheel in FIG. 1A. Please refer to FIG. 1A, FIG. 4A and FIG. 4B. In the embodiment, the driving assembly 150 includes multiple first magnets 151, multiple first coils 152, multiple second magnets 153 and multiple second coils 154. The first magnets 151 are disposed around the edge of the color wheel 130. The first coils 152 correspondingly surround the first magnets 151. A first magnetic force is generated in response to the first coils 152 being energized. The first magnets 151 are affected by the first magnetic force to drive the color wheel 130 to rotate. That is to say, the first coil 152 serves as a stator, and the first magnet 151 serves as a rotor. The second magnets 153 are disposed around the edge of the light-shielding sheet 140. The second coils 154 correspondingly surround the second magnets 153. A second magnetic force is generated in response to the second coils 154 being energized. The second magnets 153 are affected by the second magnetic force to drive the light-shielding sheet 140 to rotate. That is to say, the second coil 154 serves as a stator, and the second magnet 153 serves as a rotor. In the embodiment, the driving assembly 150 includes an annular circuit board 155. The first coils 152 and the second coils 154 are respectively disposed on two opposite sides of the annular circuit board 155 and are electrically connected to the annular circuit board 155. The annular circuit board 155 is configured to provide current to the first coils 152 and the second coils 154.

In summary, in the imaging module with the color wheel according to the embodiment of the disclosure, the color wheel disposed above the lens set is used, which includes multiple filters with different filter wavelength bands, and the light-shielding sheet disposed above the color wheel is used, which has a notch to expose a part of the filters. By driving at least one of the color wheel and the light-shielding sheet to rotate, the image sensor may sense images of lights of different wavelength bands in sequence. The images of lights of different wavelength bands may be synthesized into a color image, so that the image sensor may further sense a color image with a higher color saturation. In addition, in the imaging module with the color wheel according to the embodiment of the disclosure, since the color wheel is used to filter out lights of different wavelength bands in sequence, an image sensor with a relatively simple structure may be used, so that the cost of the imaging module can be effectively reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An imaging module with a color wheel, comprising:
an image sensor;
a lens set, disposed above the image sensor;
the color wheel, disposed above the lens set and comprising a plurality of filters with different filter wavelength bands;
a light-shielding sheet, disposed above the color wheel and having a notch, wherein the notch exposes a part of the plurality of filters; and
a driving assembly, driving at least one of the color wheel and the light-shielding sheet to rotate.

2. The imaging module with the color wheel according to claim 1, wherein a shape of the notch corresponds to a shape of the filter, and when the driving assembly drives at least one of the color wheel and the light-shielding sheet to rotate, the notch exposes the plurality of filters in sequence.

3. The imaging module with the color wheel according to claim 1, wherein the driving assembly comprises:
a plurality of first magnets, disposed around an edge of the color wheel;
a plurality of first coils, correspondingly surrounding the plurality of first magnets, wherein a first magnetic force is generated in response to the plurality of first coils being energized, and the plurality of first magnets are affected by the first magnetic force to drive the color wheel to rotate;
a plurality of second magnets, disposed around an edge of the light-shielding sheet; and
a plurality of second coils, correspondingly surrounding the plurality of second magnets, wherein a second magnetic force is generated in response to the plurality of second coils being energized, and the plurality of second magnets are affected by the second magnetic force to drive the light-shielding sheet to rotate.

4. The imaging module with the color wheel according to claim 3, wherein the driving assembly comprises an annular circuit board, wherein the plurality of first coils and the plurality of second coils are respectively disposed on two opposite sides of the annular circuit board and are electrically connected to the annular circuit board.

5. The imaging module with the color wheel according to claim 1, wherein the plurality of filters with different filter wavelength bands comprise a red filter, a green filter, and a blue filter.

6. The imaging module with the color wheel according to claim 5, wherein the plurality of filters comprise at least one of an infrared-transmitting filter and an ultraviolet-transmitting filter.

7. The imaging module with the color wheel according to claim 1, wherein the plurality of filters are in an annular arrangement around an optical axis of the lens set.

8. The imaging module with the color wheel according to claim 7, wherein a boundary between two adjacent filters among the plurality of filters is arc-shaped.

9. The imaging module with the color wheel according to claim 8, wherein each filter among the plurality of filters has an arc-shaped convex side, an arc-shaped concave side, and an arc side connecting the arc-shaped convex side and the arc-shaped concave side, wherein a rotation direction of the color wheel is a direction from the arc-shaped concave side to the arc-shaped convex side.

10. The imaging module with the color wheel according to claim 1, wherein the driving assembly drives the color wheel to rotate when the light-shielding sheet is in a static state, or drives the light-shielding sheet to rotate when the color wheel is in a static state.

11. The imaging module with the color wheel according to claim 10, wherein a rotation of the color wheel is a rotation where an optical axis of the lens set is a rotating axis, and a rotation of the light-shielding sheet is a rotation where the optical axis of the lens set is a rotating axis.
